(19) United States
(12) Patent Application Publication
(10) Pub. No.: US 2018/0033045 A1
(43) Pub. Date: Feb. 1, 2018

(54) METHOD AND SYSTEM FOR PERSONALIZED ADVERTISING

(71) Applicant: Michael Flynn, Newtown, PA (US)

(72) Inventor: Michael Flynn, Newtown, PA (US)

(21) Appl. No.: 15/729,657

(22) Filed: Oct. 10, 2017

Related U.S. Application Data
(63) Continuation-in-part of application No. 15/083,023, filed on Mar. 28, 2016.
Application No. 15/083,023 is a continuation-in-part of application No. 14/882,875, filed on Oct. 14, 2015, now Pat. No. 9,785,652.
Application No. 14/882,875 is a continuation-in-part of application No. 14/701,509, filed on Apr. 30, 2015, now Pat. No. 9,408,035.
(60) Provisional application No. 62/017,517, filed on Jun. 26, 2014.
(60) Provisional application No. 61/986,175, filed on Apr. 30, 2014.

(51) Int. Cl. G06Q 30/02

(52) U.S. Cl. CPC G06Q 30/0261; G06Q 30/0255; G06Q 30/0269; G06Q 30/0259

(57) ABSTRACT

Advertisements may be delivered through a digital display device within a defined commercial location connected to a server. A disclosed method may include the server receiving a user identifier that is within the defined commercial location, correlating the user identifier to a user profile including user preferences and a user specific visual enhancement. The server may receive a first interaction indication including a first location indication to correlate a first location of the user within the defined commercial location and a first time indication to correlate the first location indication to a first date and time. The server may store in a memory a database record including the user identifier and the first interaction indication. The server may deliver a visual digital advertisement, to the digital display device within the defined commercial location based on the database record, the user preferences and the user specific visual enhancement.

### CLAIM OF PRIORITY UNDER 35 U.S.C. §§ 119 (e)

This application is related to and claims to: U.S. nonprovisional application Ser. No. 14/701,509 titled “Mobile Computing System with User Preferred Interactive Components” filed Apr. 30, 2015; U.S. nonprovisional application Ser. No. 14/882,875 titled “METHOD AND SYSTEM FOR ENHANCING SEARCH RESULTS” filed on Oct. 14, 2015, which is now issued U.S. Pat. No. 9,785,652, issued on Oct. 10, 2017; U.S. nonprovisional application Ser. No. 15/083,023 filed on Mar. 28, 2016 titled “ENHANCED ADVERTISEMENT SERVER”; U.S. provisional application 61/986,175 filed on Apr. 30, 2014; and U.S. provisional application 62/017,517 filed Jun. 26, 2014; each of which is incorporated herein by reference.

### FIELD OF THE INVENTION

The present invention is directed generally to visual digital displays and more particularly to methods and systems for personalized advertising using visual digital systems.

### BACKGROUND

Advertisers are seeking to personalize advertising that is delivered to a user while the user is logged in to a user account which maybe done on personal computers and mobile devices. Consumers increasingly seek information and shop via online devices. Past systems, however, are limited to delivering advertising to users that are logged in to personal devices. When advertisement is personalized for a consumer, the personalization in past systems has been hidden from the consumer, and therefore the consumer does not receive the advertisement as valuable personalized information.

There is a need to deliver advertisements in ways that allow consumers to receive the advertisement as valuable personalized information, and which is not limited to the current delivery methods through personal devices.

### SUMMARY

A computer implemented method of delivering advertising through a digital display device is disclosed for use within a defined commercial location. The digital display device may be communicatively connected to a server. The method may include receiving, by the server, a user identifier of a user that is within the defined commercial location and receiving, by the server, a first interaction indication. The first interaction indication may include a first location indication to correlate a first location of the user within the defined commercial location; and a first time indication to correlate the first location indication to a first date and time.

The method may include storing in a memory by the server, a database record including the user identifier, the first interaction indication; and a second or additional interaction indications. The second or additional interaction indications may include a second or additional location indication to correlate a second or additional location of the user within the defined commercial location and a second or additional time indication to correlate the second additional location indication to a second or additional date and time.

The method may include delivering a visual digital advertisement, by the server, to the digital display device within the defined commercial location based on the database record, and correlating the user identifier to a user profile including user preferences. The visual digital advertisement may be delivered based on the user preferences, and with a user specific visual enhancement including a user color that is included in the visual digital advertisement.

In some embodiments the user specific visual enhancement may include a repeating visual variation of the user specific visual enhancement, or a cycle time of the repeating visual variation.

The first interaction indication may include a first direction of travel indication that indicates a direction of travel of the user. The first interaction indication may include a first emotional response indication to indicate an emotional response of the user. The first emotional response indication may include a facial recognition input from a digital camera, and the computer implemented method may include determining whether the user is smiling based on the facial recognition input.

The method may include correlating the delivery of the visual digital advertisement with the first emotional response indication to determine if the user smiled in response to the delivering the visual digital advertisement.

In some embodiments the digital display device may include a representative display associated with a specific representative of the defined commercial location. Delivering the visual digital advertisement may include delivering the user specific visual enhancement to the representative display to indicate to the user that the specific representative is prepared to serve the user.

The method may include correlating the specific representative with the user based on the user profile. Correlating the specific representative with the user may be performed prior to delivering the user specific visual enhancement to the representative display.

In some embodiments the digital display device may include an augmented reality display. Delivering the visual digital advertisement may include highlighting a portion of the augmented reality display.

The digital display device may include a merchandise display that is associated with an item of merchandise. Delivering the visual digital advertisement may include displaying the user specific visual enhancement on the merchandise display.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an example flow diagram of a process of using a personal glow in advertising in a commercial space.

FIG. 2 is an example flow diagram of a process of using a personal glow account in advertising.

FIG. 3 is an example flow diagram of a process of using a personal glow ad feedback in advertising.

FIG. 4 is a flow chart of an embodiment of a system for setting up a user account profile with a personal glow.

FIG. 5 is an illustration of an embodiment of a ad database and system for delivering personalized glow advertisements to ad platforms.

FIG. 6 is an illustration of an embodiment of an ad database with personalized glow ads.

FIG. 7 is a block diagram of an embodiment of an ad server system.

FIG. 8 is a front elevation view of an embodiment of the portion of the communications terminal display screen showing an example splash glow;

FIG. 9 is a front elevation view of an embodiment of the portion of the communications terminal display screen showing an example star glow;

FIG. 10 is a front elevation view of an embodiment of the portion of the communications terminal display screen showing an example bubble glow;

FIG. 11 is a front elevation view of an embodiment of the portion of the communications terminal display screen showing an example sun glare glow; and

FIG. 12 shows an exemplary illustrations of an interactive user communication with a mobile device wherein the device provides the user a variety of information.

FIG. 13 is an example embodiment of a user in a commercial location.

FIG. 14 is an example embodiment with representative displays used in a commercial location to communicate using a personal glow.

FIG. 15 is an example system for delivering information using a store front.

FIG. 16 is an example embodiment of a glow showing seating in an arena using an augmented reality device.

FIG. 17 is an example embodiment of a glow showing seating at a bar using an augmented reality device.

FIG. 18 is an example embodiment of a glow showing seating at a restaurant using an augmented reality device.

FIG. 19 is an example embodiment of a glow showing produce at a grocery store.

FIG. 20 is an example embodiment of a window display ad with glow.

### DETAILED DESCRIPTION

The present disclosure references a mobile device as well as other devices. As generally understood a mobile device can be a computer that includes one or more processors and can include or be in processing communication with a display. The present disclosure discusses mobile devices but is not limited to mobile devices. Display devices may include screens or displays on mobile devices, visual headsets, contact lens computer display, projectors, lights, and other types of displays. A display may include images projected into a 3-D space with or without the use of a headset such as an augmented reality headset or a virtual reality headset. In some embodiments a device may include a user interface device, and in other embodiments a device may not have a user interface device. A mobile device can include a variety of apparatus, including but not limited to mobile phones and mobile tablets, HUD's (heads up displays), headsets, glasses, watches or other IOT devices, wearable devices including devices worn on any part of the body among others. Mobile devices are not limited to phones but can be glasses or even contacts. A visual digital advertisement in this application may include placing a glow around or next to a product, a group of products, a display of a product. A visual digital advertisement may also include placing a glow around or next to a section of a quantum advertising zone, or visual or auditory directions within a quantum advertising zone. A visual digital advertisement may also include the display of a personal glow without a product display or traditionally advertisement message.

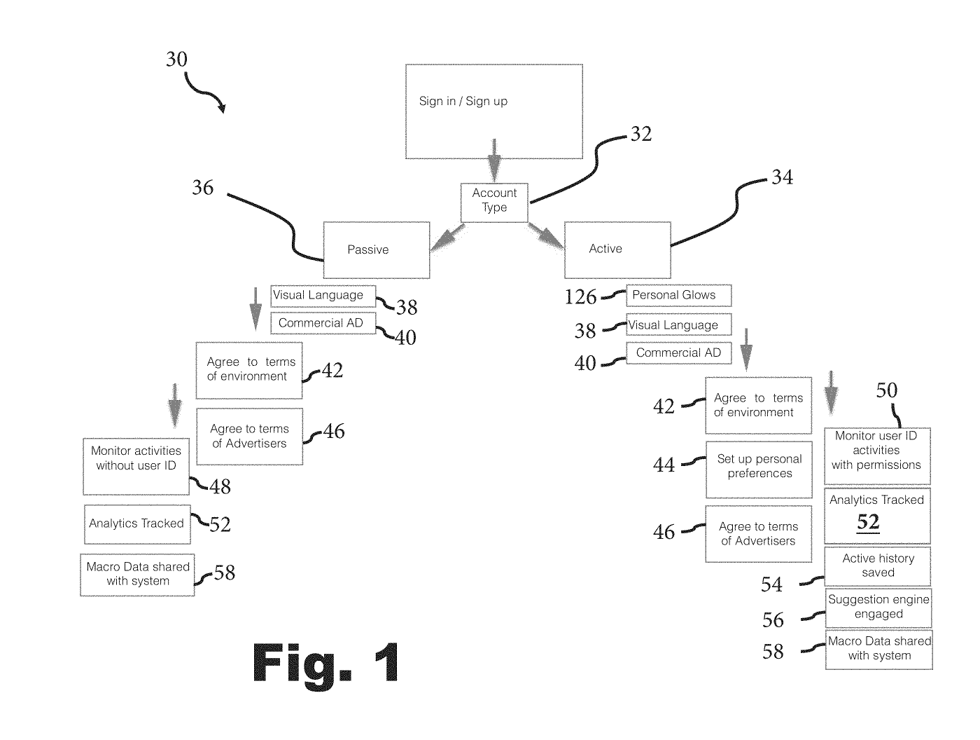

For a general understanding of disclosed embodiments, reference is made to the drawings, FIGS. 1 through 20 herein. The matter shown in phantom, or dotted lines, illustrates environmental structure and forms no part of the disclosed design. Reference numerals are used to designate elements as defined and described below. The present disclosed embodiments will be described by way of example and not limitation. Modifications, improvements and additions to the disclosed embodiments described may be determined after reading this specification and viewing the accompanying drawings; such modifications, improvements, and additions being considered included in the spirit and broad scope of the disclosed embodiments and its various embodiments described or envisioned herein.

A personal glow may be a specific visual enhancement that individuals can choose or be assigned. The personal glow may be a unique “glow” which is their personal signature, an electronic tag they and others recognize as indicating a particular individual as the target or source or recommender or seeker. In some embodiments a user selected visual enhancement may be a personal glow. Examples of personal glows are shown in several of the figures including FIGS. 8 through 12 and FIGS. 14 through 20.

A “glow” may include any visual, auditory or sensory feature or a combination thereof. A glow design engine permits a user to create a one-of-a-kind, customized glow effect using parameters such as specific colors (i.e. tone, shade, saturation of each). In some embodiments a single specific color may be used as a personal glow. Glow may include a repeating visual variation. The cycle time of the repeating visual variation may be a frequency that a user can select. Examples include: frequency of alternating colors, frequencies of alternating transparency, frequency of alternating hue, frequency of shape or image cycle style of alternating colors (fade slow, fade fast, no fade, for example). Glow may include overlay animation effects (for example, five-pointed stars emanating from the center of the frame with tails; five-pointed stars without tails, four-pointed stars emanating from points throughout the frame, bubbles, sunbursts, brand logos, sports team mascots, etc.). In some embodiments a glow may include sound parameters, vibration parameters, and a multitude of other parameters governing visual, auditory or sensory elements. One person's personal “glow” may be specifically designed and customized for and, in some cases, by that person so that it is different from any other glow effect. With a unique glow, a user may recognize his or her personal glow, and the personal glows of his or her friends, colleagues or people he or she follows, for example people the user follows on social media.

As an example embodiment user A's personal glow may be a frame of a particular shade of blue, such as (red, green, blue or rgb) rgb 7, 69, 239, pulsing with a brighter, related shade, say rgb 114, 145, 229 at 60 beats per minute or bpm with a multitude of yellow rgb 255, 255, 0 five-pointed stars emanating from the center of the framed content leaving downward-curving tails made up of 5 downward curved, fine point, with no sound or vibration component. User B's personal glow may use the same shade of blue but pulsing with a darker related shade with a multitude of orange basketballs and incorporating the sound of a crowd cheering and vibration lasting two seconds signaling the beginning of the glow effect.

Personal glows can be used in numerous ways, some commercial some social. A person may design his or her personal glow using a glow design engine. A person may choose to incorporate whatever elements and features they desire for their personal glow, including not just visual effects and personal colors but also sounds, tones, vibration effects and the like, thus arriving at a unique, signature, glow they recognize (and others in their network recognize) as signaling a connection to that user.

Components of the System may include sensors of various kinds, including but not limited to sensors in user's wearables and business representative's wearables (glasses, watch, bracelet, headset/earbud, clothing, hat/cap/headwear, jewelry, footwear, contact lens computer display), accessories (briefcase, handbag, satchel, tablet, phone, pen/stylus); sensors in the physical place (in shopping carts and baskets, in walls and fixtures, windows, doors; and/or at registers; and/or at product displays and/or kiosks; and/or at screens and signage; and/or on interior or exterior walls; and/or in parking lot, walk-up feature, outside order windows); and/or sensors in the virtual space (website, social media pages, interactive electronic ads and offers displayed on/in other websites or apps as is known in the art via the supply/display auction system or another system that delivers ads to a plurality of publisher webpages).

Sensors as used herein is meant to encompass both receiving and transmitting sensors, i.e. sensors which receive information from transmitting components of the system and sensors which transmit (send) information through the system, understanding that the receiving sensors and transmitting sensors may be the same sensor, adapted to both receive and transmit information, or the receiving sensors may be separate from the transmitting sensors but the separate sensors packaged together or in relatively close proximity in the same device or location such that a set comprising a receiving sensor and a transmitting sensor is equivalent to a sensor capable of both receiving and transmitting information.

Components of the system may include software algorithms, software tags, software codes including “quantum numbers” and filters as previously disclosed and as disclosed herein. The glow and the a quantum consumer number may be used in tandem to advertise a commercial opportunity using the glow system disclosed and disclosed in prior applications.

In some embodiments components of the system may include, but are not limited to, a glow design engine; an advertisement database; an info feedback database; a user account database.

A server may create a quantum number for one or more users within a fixed geographic space. A fixed geographic space or area where a system is building a quantum number maybe a quantum advertising zone. In some embodiments a quantum advertising zone includes the location of a commercial establishment, and an area around or adjacent to the location of the commercial establishment. For the purpose of this disclosure, a quantum number may include a string of characters that indicate one or more interactions and when a new interaction occurs, the new interaction is added as an additional set of characters.

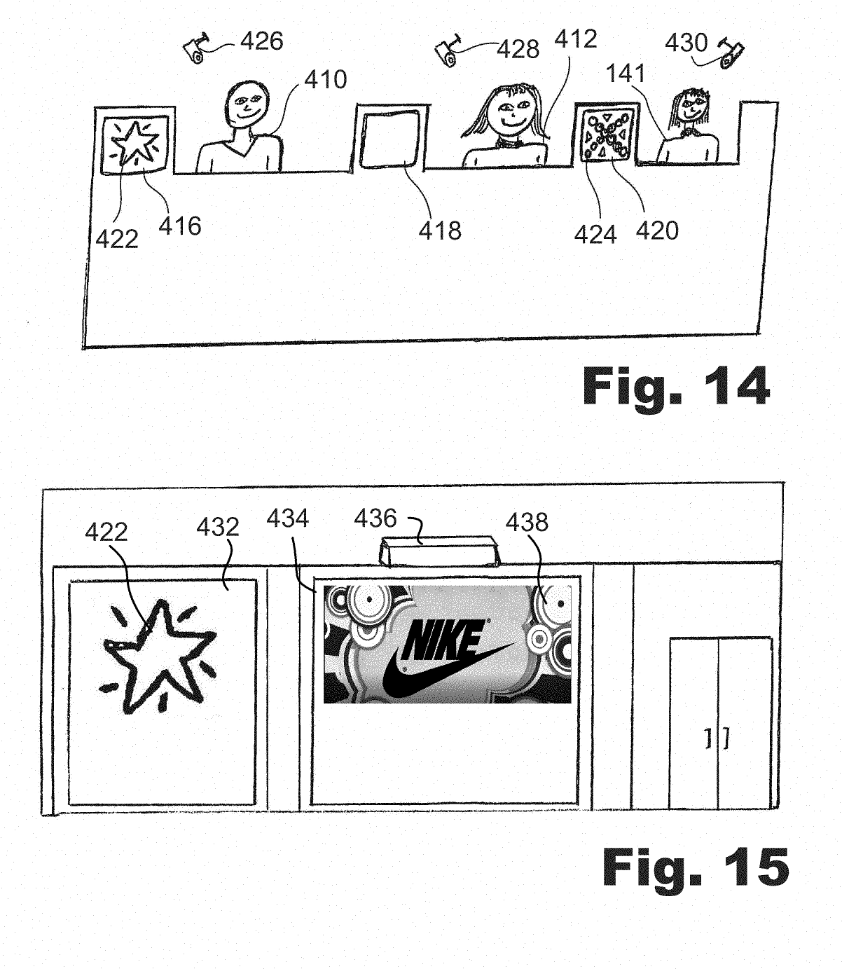

FIG. 14 shows a user 510 in a commercial location. The system may determine the location 512 of the user 510 and determine commercial opportunities based on the current location 512. The commercial opportunities can be used to deliver advertisements, or to track users to measure a base line, or to measure a current online or offline advertising campaign. In an example embodiment the system may detect when the user 510 moves in a first direction 522, a second direction 524, a third direction 526 or a fourth direction 528. When a user moves in a first direction 522, the system may determine a first new commercial opportunity based on the new location and based on the prior locations. The system may track the locations where the user travels, the direction of travel, the speed of travel (regardless of the mode of travel such as walking, bicycling, riding in a vehicle, etc.). The new commercial opportunity may be determined based more than one past location of the user.

In some embodiments the quantum number may be formatted as [user indicator][date/time1, location1, interaction1] [date/time2, location2, interaction2] [date/time3, location3, interaction3], etc. The quantum number may be stored as a database record. In this disclosure a database record may include a single row in a database, and it may also include multiple rows in a database.

An interaction indication may be whether a user spends time in a location or not, or whether they look at a display. For example, if a quantum advertising zone is a mall or plaza, the system may track a user as the enter the quantum advertising zone, and if they walk past a store without entering the store, this may be recorded as an interaction. Interactions may be recorded as interaction indications in sequence of the movements and interactions of the user.

A system may continue building a quantum number while a user is within a quantum advertising zone. The quantum number may be a record of interactions that a user has within a quantum advertising zone.

As an example a user may enter a store using a system that builds a quantum number. The system may include a passive mode and an active mode.

In passive mode a user may not be associated with a personally identifiable user profile, for example an opt-in profile. A system may use facial recognition or other biometrics to track the user and record the quantum number.

In some embodiments a device or combination of devices may track a user's movements an interactions to create a quantum number. Devices for tracking a user may include cameras, electronic devices attached to shopping carts that track the location of the shopping cart, mobile electronic guides, signals from personal electronic devices, or other devices with sensors or input devices.

In passive mode, a user may be monitored without a user ID. For example facial recognition may be used without connecting to a database that shows the identity of the user. The facial recognition may be used to determine when the same user interacts with a display and when they leave the quantum advertising zone. Passive mode may still be used to personalize advertisements within the quantum advertising zone. In an example embodiment the system may be implemented in a grocery store and a user may be monitored by the system starting when they enter the store or when they enter the property of the store. The system may track how much time is spent in a section or location within the store. For example, the produce section of the store. If a user spends a threshold amount of time in the produce section, then advertisements may be displayed where the user can see it. The displayed advertisement can be correlated to the preferences of previous users that spent at least the threshold amount of time in the produce section, such as advertisements for products in an organic section of the store.

Analytics can be tracked in a passive mode to determine general information such as correlation between time spent by users in different parts or departments of the store, and to deliver advertisements and measure whether advertisements make it more likely that certain users will shop in certain sections.

Analytics information may include the total amount of time spent within Quantum Advertising Zone. The time spent in each section of the Quantum advertising zone, the sequence or order of where a user spent time within the zone, opportunities a user had to interact within each section of the advertising zone and which of the opportunities to interact had an interaction by the user.

In some examples the quantum advertising zone is a single store in other examples the quantum advertising zone may be multiple stores such as a mall or shopping plaza.

In some embodiments an active mode of a system may include correlating the user ID to a user profile with preferences. The preferences of the user may include a personal glow of the user, as well as personal preferences of brand, style, size, quantity, and other preferences and user history and interactions. A user's profile may include preferences, location information including current location and past locations, ratings that the user has given products, or ratings determined based on a user's interactions, history of purchases and web browsing and other gathered information related to the user.

The system may automatically deliver advertisement which are useful to the user based on the current interactions, or based on the preferences.

In an example embodiment a quantum advertising zone may be a shopping plaza, and the user may have an opt-in to allow tracking of the user while in the shopping plaza. When a user is within a threshold proximity to a store within the quantum advertising zone, such as a distance where they are able to see an advertisement, a display may show information automatically selected based on the user profile. The advertisement may include a personal glow that is selected by the user.

Visual digital advertisement in this application may include placing a glow around or next to a product, a group of products, a display of a product, a section of a quantum advertising zone or visual or auditory directions. Visual digital advertisements may also include video, still images, and advertisements commonly used as of the filing of this application. In an example embodiment, a store may have a projector or display on the outside of the store that displays a personal glow of a user when a user is within proximity of the store and there is a product or service that is correlated to the user's profile. A specific example may include a dry cleaner within a mall that is a quantum advertising zone. The dry cleaner may have dry cleaning that needs to be picked up by the user, and when the user is within proximity to the store, a display may show the user's personal glow as an advertisement to remind the user to pick up their dry cleaning. In some embodiments the system may determine an interval of when a specific customer enters a certain store, and if the specific customer has not entered the store within a specific interval the advertisement will be shown when the user is within proximity of the store to remind the user to come into the store.

By using the personal glow of the user, the user may be more likely to notice the advertisement, as they may have a heightened awareness to the advertisements with their personalization attached or associated with the advertisement.

Referring to FIG. 1, a diagram of a user sign in/sign up process and system 30 according to some embodiments is disclosed.

In some embodiment a system 30 may determine an account type 32 for a user and may recognize a user as an active user 34 with an active profile as an active user, or may proceed with a user that does not have an active profile as a passive user 36.

With a passive account, as a user may benefit from a visual language module 38 and commercial ads 40. Visual language 38 may include features to guide and respond to a user's queries, for example by responding to a user's voice query asking for a specific product in a commercial location. The visual language module may initiate a search through the commercial location's inventory and stocked items to determine if the store carries the specific product, and whether the product is in stock. The visual language module 38 may display a picture to the user of the product that is in stock, and may display directions to the location of the item, or provide an augmented reality interface through the user's device or through devices within the commercial location to direct the user to the desired specific item.

The commercial ad module 40 may display ads to direct the user to sales or featured items. The ads displayed may be based on the search query of the passive or the active user. For example if a user queries breakfast cereal or cookies, the system may respond by providing information about the breakfast cereal or cookies, and may also display a commercial ad for milk. When a user is an active user, the system may return results based on the user's profile and preferences. For example if a user queries cookies and the system may determine the brand or type of milk that is preferred by the user based on prior purchases or questions answered or other feedback gathered by the system.

An active user 34 may also benefit from personal glows 126, which may be a user selected glow as discussed in this application, which may alert the user to preferred items by placing a glow around the item or the section of the commercial location in an augmented reality display. In some embodiments a commercial ad 40 may be delivered with preferred products and a personal glow 126 to communicate to the user that this item is selected specifically for the user.

In some embodiments, passive users 36 and active users 34 may be given an opportunity to accept and agree to the terms of monitoring 42 in the environment of the commercial location. Agreement to monitoring may be through an acknowledgement when an app is downloaded to a mobile device. Agreement to monitoring may be based on a notice posted to alert a user that activities may be monitored and recorded. In some embodiments no notice is given to a passive user if the user is not entering any space where they have an expectation of privacy.

An active user 34 may be given an opportunity to set up personal preferences 44 by answering questions. In some embodiments an active user may import into the system their data from other systems that may show past purchases or preferences entered into other systems.

A passive user 36 and an active user 34 may agree to terms of advertisers 46 to allow advertisers to use data to personalize ads as described and in other ways. Agreement may be done in the same manner as the agreement to the terms of the environment 42.

A passive user 36 may have activities and engagement monitored without any user ID information 48, meaning analytics tracking 52 and macro-data 58 may be shared with the system will without identification that links the person to a user identifiable information. A both the active user 34 and the passive user 36 may be given a user identifier by the system, but the system only connects to user identifier to a user profile for an active user. In some embodiments a user may have a user profile, but chose to opt out for an interaction or time in the commercial location. When a user is treated by the system as a passive user 36, the user's movements, reactions, and interactions may still be tracked by the system as macro data, without connecting the data to a user profile.

An active account 34 means a user may create or be assigned a personal glow 126 as well as benefit from visual language 38 and commercial ad 40, meaning the user will be able to set personal preferences, benefit from the suggestion engine 56, have his history of engagement saved 54 in the system and have his activities monitored with the user identifier linked to the personal user ID and with permission 50.

For a passive account 36, a user agrees to the terms of the engagement in an environment 42, which may be a physical environment such as a particular restaurant or airport or store, or a virtual environment such as Facebook® (social media), Google® (search engine), Gmail® (email), Amazon® (online store), Huffpost® (content publisher) or a mobile application such as a text message application, and agrees to the terms of advertisers 46. Use of the system for a passive user, according to some embodiments, is disclosed and illustrated in FIG. 1.

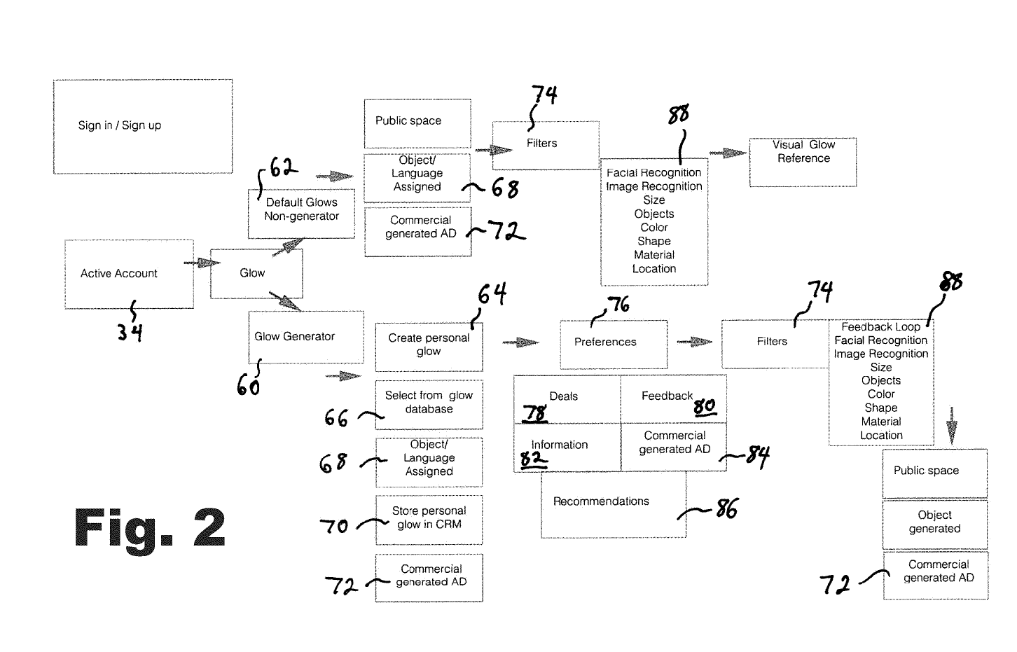

For an active account 34, a user agrees to the terms of the engagement 42 in an environment, sets up his personal preferences 44 and agrees to the terms of advertisers 46. Use of the system for an active user 34, according to some embodiments, is disclosed and illustrated in FIG. 2.

In one embodiment, the system uses the sensors (to the user and from the user) to collect real-time data in the form of numbers corresponding to the user's movements through the physical space and interactions with the system, for example. The system continues to collect such data, recording the values over time, until the user passes out of a quantum advertising zone. An interaction may pass through three loops, described as follows:

FIG. 1 shows a first loop pass which may be an info loop. The purpose of this loop may be to trigger the system and learn about the person. A person walked in, are they an active user 34 or a passive user 36, the system may also determine what devices a user has enabled. For passive users 34, data may be collected and aggregated anonymously and no personalized ads or offers are delivered based on a user profile, but an ad may be personalized in other ways. Both active users 34 and passive users 36 may be monitored and the system may generate “macrodata”—general, aggregated consumer behavior data with timestamps of interactions but no personalization, identification or demographic information. The system may monitor active users to generate “microdata”—specific information about a particular, identified consumer and their movements and interactions with a brand or business. Each parameter of information collected in the info loop is assigned a value corresponding with the information collected, forming the beginning of a quantum number.

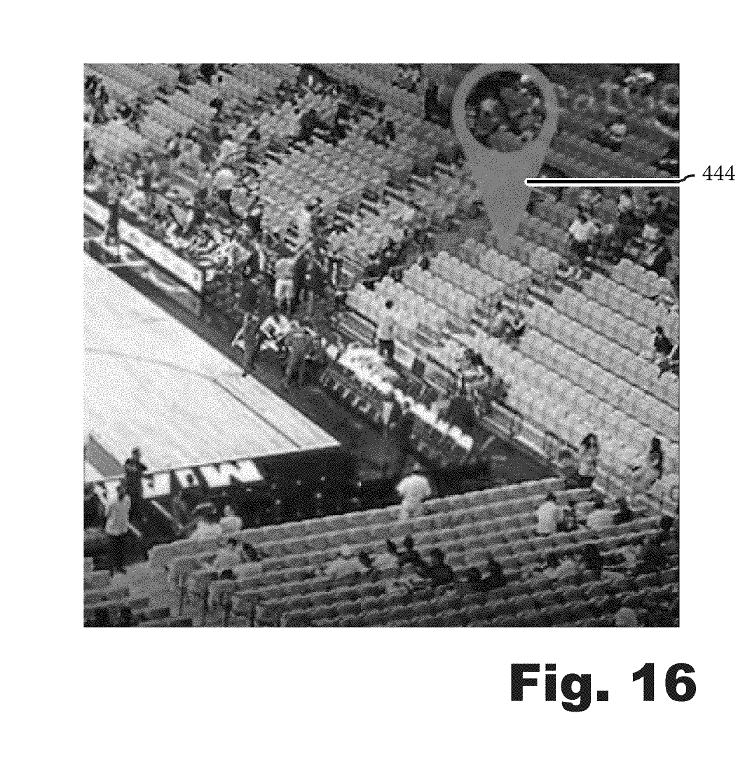

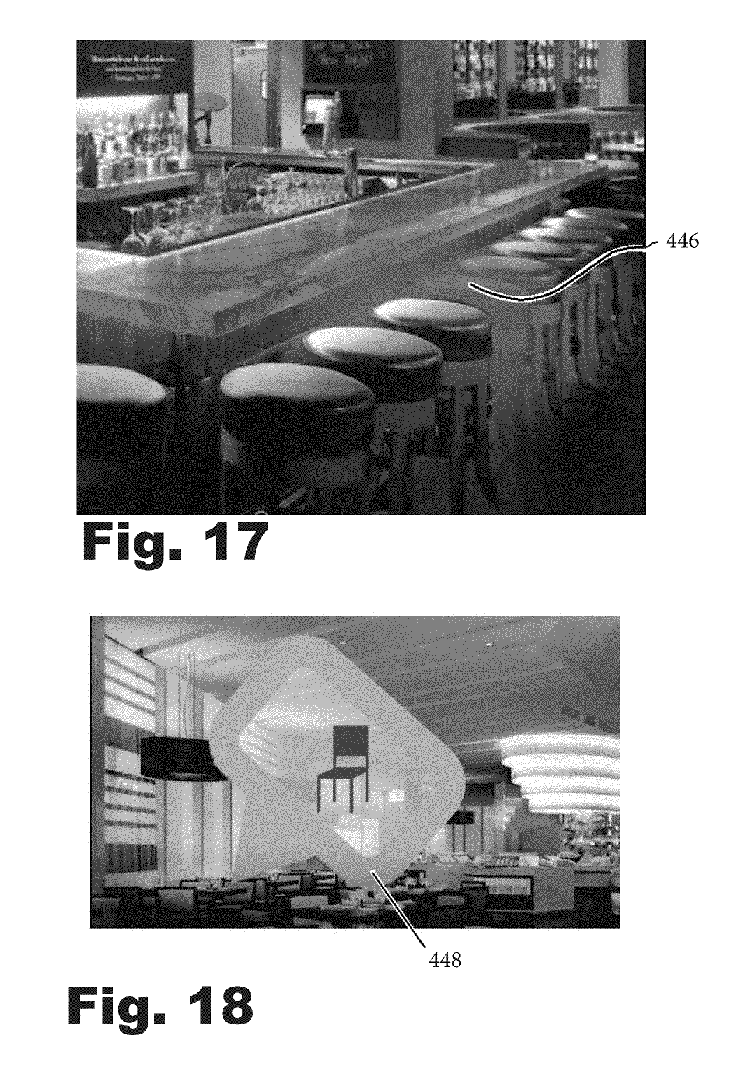

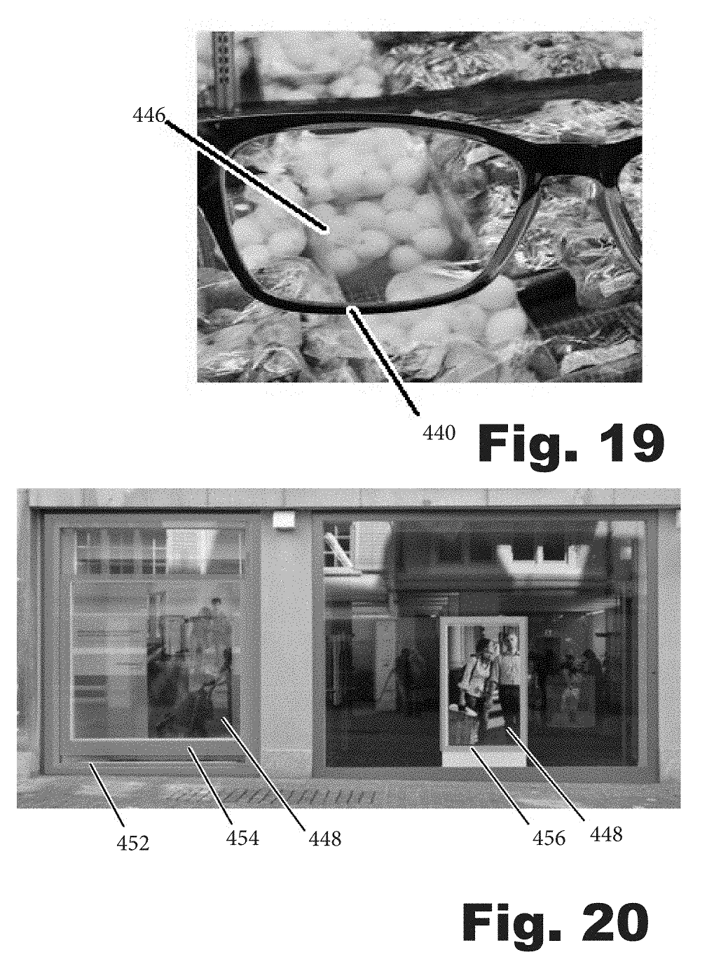

FIG. 2 shows options and information that a may be part of an active user's setup and profile. For a user with an active account 34 the user may choose to generate a personal glow using a glow generator 60, or may choose to use default glows in a non-generator path 62. The glow generator 60 may allow a user to create a personal glow 64. Creating the personal glow 64 may include the steps of selecting options from a glow database 66, such as selecting templates, and themes. A user may select a way in which a glow will be applied to an object. FIG. 16, FIG. 17, FIG. 18 and FIG. 19 show ways that an object glow may be accomplished as discussed below. In some embodiments the user may select the object/language assigned 68 for an object glow or language used. In some embodiments the type or manner of glow for an object is assigned automatically, or assigned by the commercial location owner or an advertiser.

After the personal glow is selected or assigned and options for glow types are selected or assigned, the system may store the personal glow in a CRM (customer relationship management) system 70 or in another type of database.

In FIG. 16 a pin glow 444 is shown using augmented reality for a user to locate their seat in an arena. In some embodiments the user may select the color of the pin glow in the setup. The pin glow is applied to the seat as the object as selected by the user in the object/language assigned selection 68 (from FIG. 2).

In FIG. 17 the object that is glowing is a bar stool that is available for a user. The glow may be applied using an augmented reality device. In the example of FIG. 17 the bar stool has a transparent green highlight 446. The user may select how glow is applied to an object such as a seat at a restaurant, merchandise at a store, a menu item on a menu, a store. The user may select the color, or may select different colors to represent different options for glow applied to objects using augmented reality.

FIG. 18 shows another embodiment of how a glow may be applied to an object. In the example of FIG. 18 a system may indicate to a user through an augmented reality device that a table is available at a restaurant. In some embodiments the restaurant may provide part of the image that will be shown in the augmented reality device. In some embodiments the user may select a visual balloon glow 448.

FIG. 19 shows an example of a personal glow used in a grocery store. A user may use a display device such as augmented reality glasses 440. In the example of FIG. 19 the transparent green highlight 446 is applied though the augmented reality glasses 440 to the lemons to let the user know information about the lemons. In some embodiments a user may query the system, for example using a voice command, to find out more information about a product, or differences between products. In the example with the lemons, a user may query the system to ask which lemons are the freshest. The system may receive information from tags that are on the bags of lemons to determine which ones are the freshest, and the highlight the freshest lemons for the user. In other embodiments a user may query to determine other information about products and the system may apply a glow to an object in answer to the query. The glow may be applied in many ways as described in this application an the applications incorporated by reference.

FIG. 20 shows an example store window with ads 448 and personal glows. A first personal glow 452 is shown in green around the window ad on the left, and a second personal glow 454 is shown in purple around the window ad on the left and inside the first personal glow 452. A third personal glow 456 is shown in light blue around the ad 448 on the right. The personal glow may be used to alert a user that the display ad is displaying an item that is a preferred item of the user as they pass in front of the window ad. The glow may prompt a user to go into the store to find out more about the offer that matches their preferences.

One or more commercial generated ads 72 may be generated by the system, which may be selected based on the available information, and may incorporate a default glow or a personal glow. In some embodiments a default glow may be used with an advertisement when the advertisement is used in a public space and is likely to be seen by multiple people. In some embodiments a user may select more than one personal glow, and may have a social personal glow and a private personal glow. Filter

FIG. 2 may represent a second loop pass of gathering information, which may be an engine Loop, and may be for active account users 34 only. The purpose of this loop may be to determine what content will be delivered. The system may determine the user's preferences and history. The system may determine filters 74 that the user has chosen, or filters 74 that are useful based on preference, location, rating, history and other factors. Filters 74 may be applied to increase enjoyment and success, which may lead to increased sales for this user. Predictive analytics and machine learning may be used in the selection and delivery of the advertisements. Preferences 76 may include deals 78, feedback 80, information 82, commercially generated ads 84 already stored in the ad database, recommendations 86 or other preferences.

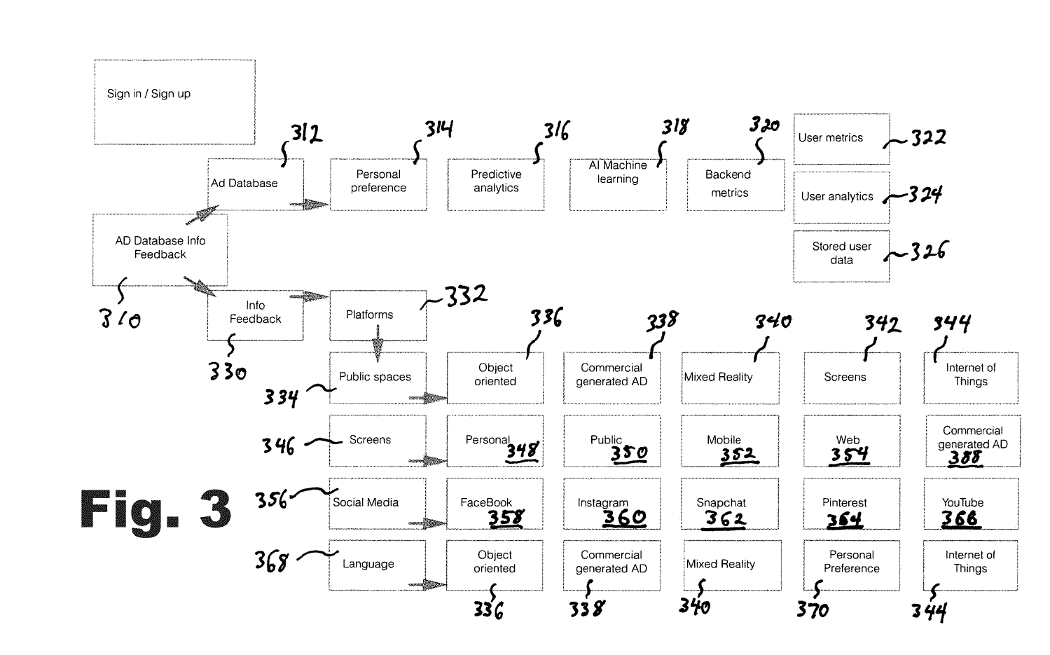

FIG. 3 may represent a third loop, which may be a feedback loop. The purpose of this loop may be to determine the effectiveness of the content correlated with how the content was delivered. The system may analyze the quantum number and runs it through the active filters, assigning a value to each depending on the quantum number. The quantum number may include when an how an ad was delivered to the to the user.

Once the Ad is delivered to the User, the system monitors actions by the user in response to the ad. In some embodiments no response from the user may be tracked as “no response” and this is recorded, via a value (such as 0) assigned at this “action” parameter of the quantum number. In this way, the system learns what does not work for the user, and the system may continue to refine ads via passing the new quantum number (with the “no response” value added) through the three loops again, where the system monitors again for an action by the user. In the second loop, for example, the ad content may be refined to give a discount or give a bonus item free. The ad may continue to be refined in this way, by repeating the loops with the new information (no response) each time until a user action is recorded. Throughout the process of refining ads until the user engages, the system tracks and collects the user behavior information for analysis, which may become part of the user's digital profile and the user database through which the system's Al learns what the user responds to. This constant feedback is superior to any polling or survey answers as the system measures what the user actually does, not what the user reports doing or believes she will do. In some embodiments a facial expression captured can be an emotional response indication. For example, if a user is shown an advertisement and they smile in response to the advertisement, this is a response, and may be an emotional response indication that is indicated as part of the quantum number.

FIG. 3 shows gathered information including backend metrics 320 which may be gathered and stored, including user metrics 322, user analytics 324, and stored user data 326. The system may run the information gathered (and stored in the quantum number) through an analysis of the applicable backend metrics, using predictive analytics 316, and artificial intelligence (machine learning) 318 to choose additional filters and preferences for this interaction and future interactions. A parameter corresponding to a preference and/or filter may be assigned a value corresponding with the preference and/or filter. The second section of the quantum number, the section generated via the engine loop, may include a preference indication, which may be stored in the third loop shown in FIG. 3 as personal preference 314. The preference indication may be added to the quantum number for that user experience, refining the quantum number with additional information.

The system may receive information in a feedback loop which may be received through facial recognition, image recognition, information about a product such as size, objects, color, shape, material or information about the purchase such as the location. The feedback loop information 88 may be stored as macro data, and may also be stored as micro data, depending on whether the user has opted out of associating data with their user profile.

Use by an advertiser of a system and process according to some embodiments is disclosed and illustrated in FIG. 3. A user in a physical space may be presented with opportunities to interact with the system via offers to purchase something, offers to take a poll, offers to give feedback, offers to view options, offers to learn more, offers to view others' feedback or other opportunities as well as other opportunities as disclosed in the application. An opportunity may be assigned a number to be added to the user's quantum number upon delivery to the user. A user either interacts with an offer, in which case the interaction and its time are added to the user's quantum number.

As used above, “added to the user's quantum number” means it is tagged on to the end of the quantum number, not added as in tabulating a sum. The quantum number may be a chain of parameters recording a user's options, movements and interactions in a particular physical space and the time or relative time of each, such that the more interactions or potential interactions a user has within a space, the more parameters, or “links” in the chain, that quantum number may have. Once a user leaves the space, the quantum number representing that user's interaction in that space may stop growing and changing.

At that point when the user ends their interactions in the quantum advertising zone, the quantum number represents a recording of the user's interactions (including “no action” choices), movements and choices in that space, which data may be stored, graphed, mapped, analyzed and collected. This collected data may be ad database info feedback 310. Collected data may be stored in a database containing that user's preferences, likes, dislikes, glows, brands, offers and/or options and may be used to help the system anticipate that user's likes and dislikes so that the system is better able to direct offers and opportunities of interest to that user. Collected data also may be analyzed and/or sold or licensed, with or without personally identifying information, and aggregated according to various parameters, to better understand customer behavior in a space, for example.

In some embodiments, certain parts of a quantum number may be used to indicate how close a user is to a potential purchase. For example, as the user interacts with opportunities in the sales funnel, his quantum number recording his interactions indicates whether he is moving closer to a sale or further from a sale. In this way, businesses and brands gain insights into each user's unique ways of interacting with opportunities and can use the insights gained by delivering, through the system, increasingly refined sales or engagement opportunities specifically targeted to that user's ways of interacting. Refinement loops may be used to deliver increasingly refined opportunities to a particular user.

FIG. 3 shows an example refinement loop as the info feedback 330 gained from gathering a quantum number may be used in delivering advertisements and offers through various platforms 332, as well as a comparison between strategies and advertisements that are effective in different platforms. For example data may be stored with tags to show how the ad was delivered and the results of the ad. Tags may include whether an ad was delivered in public spaces 334, whether the ad was object oriented 336, whether the ad was a commercial generated ad 338 or whether a personal glow was delivered without a commercial generated ad, whether the ad included mixed reality 340 such as virtual reality or augmented reality, what type of screen 342 or display was the advertisement shown on, whether the advertisement was delivered though an internet of things device 344. The system may also have tags for the type of screen or display used to deliver the ad, including personal 348, public 350, mobile 352, as part of a website 354, and whether the ad was commercially generated 338.

Info feedback 330 may also record whether the ad was delivered or shared through social media 356 including but not limited to Facebook 358, Instagram 360, Snapchat 362, Pinterest 364, YouTube 366, or through other social media. Info feedback 330 may record the type of language 368 used in an ad such as the tone, mood, style or other language element of an advertisement, including whether the advertisement is object oriented 366 or word oriented, whether the ad was commercially generated 338 and therefore has a commercial language message, whether the ad is delivered (or deliverable) through mixed reality 340, whether the ad was delivered based on a personal preference 370, and whether the ad was delivered, or is deliverable, through internet of things devices 344.

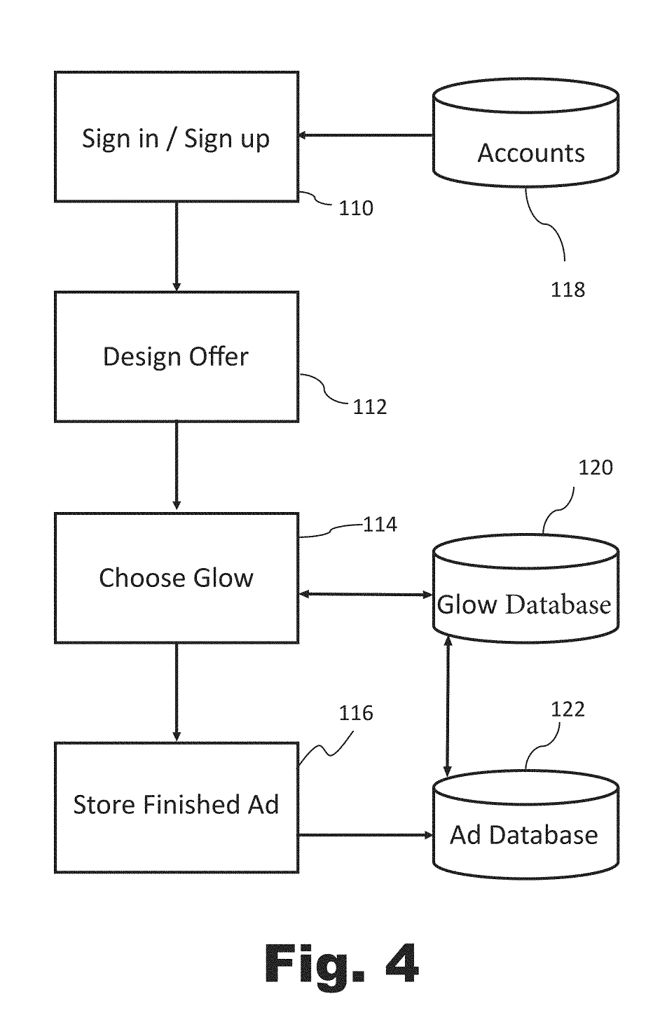

Referring to FIG. 4, an example glow server system may be used by an advertiser and by a consumer (user). The system may include an advertiser portal and a user portal. Advertisers and users may begin using the example glow server system by creating an advertiser account, or logging into a previously created advertiser account through a sign up interface 110. The glow server system may store information regarding the advertiser account and the user's account in an account database 118.

The advertiser may then design an offer or advertisement through an offer design interface 112. An advertiser may upload an offer or advertisement that was previously created on a different system, or select an advertisement that was previously created for use or modification. An ad designing engine may be used to create the offer or advertisement. An ad design engine may allow various glows in the ad, which may be users personal glow 126. The advertiser and the user may use a glow selection interface 114 to create glows that will add an effect to the advertisement or offer.

In some embodiments an advertiser may create an ad designed to have a glow element, and also design one or more glow elements. If the system determines that a user's profile matches or is correlated with attributes of the ad or the offer, the user's personal glow may be inserted into the ad. The system may deliver the add without correlation to specific user profile, and may use a glow effect designed by the advertiser. A glow database 120 may store glow effects including advertiser glow and personal glow to be inserted into the advertisement or offer. The glow database 120 may communicate with the ad database 122 to deliver advertiser glow and personal glow to ad database 122. In some embodiments an advertiser may create custom effects including custom glows that may include brand images, brand sounds or brand colors or other effects that are desired. In some embodiments an advertiser may create an advertisement or offer that does not include a glow effect.

The advertiser may use an ad storage interface 116 to store a completed advertisement in an ad database 122. In some embodiments a completed advertisement is prepared for the glow to be inserted later when a decision is made by the server whether a user glow or an advertiser glow will be inserted into the completed advertisement. The advertisement may be stored in the ad database 122 and sent to a user with the glow when it is called by an advertisement server. The ad storage interface 116 may prepare the glow ad to be exported to the advertiser's (or a third-party's) database in which it is stored and delivered to a user when called.

In some embodiments, the offer design interface 112 may allow access only by advertisers. In other embodiments users may have access to the offer design interface 112 to design their own templates for insertion of their friends glows, for example on social media sites. The ad designing engine that is part of the offer design interface 112 may include an ad content module, an offer content module and an ad rules module. An ad rules module may collect advertiser choices with respect to various attributes for the ad. Ad attributes may include target user demographics, target user interests, target user preferences, geographic region/scope, ad spend/budget, platform(s) for delivery, type of ad or offer, terminal impression (desired final action).

The glow design interface 114 may collect advertiser and users choices with respect to various glow effects selected from a library of pre-built glow effects. The glow design interface 114 may include a glow design module that may collect advertiser or user choices with respect to various attributes for the glow. Glow attributes may include color, speed, direction, animation, birth rate, or other variables and custom attributes, such as uploading a brand logo or trademark color. The glow design interface 114 may include a glow insertion module that may include an upload link where an advertiser may upload a traditional static ad. The glow design interface may also include an ad design parameter collection component; a glow parameter collection component; and a packaging and export module.

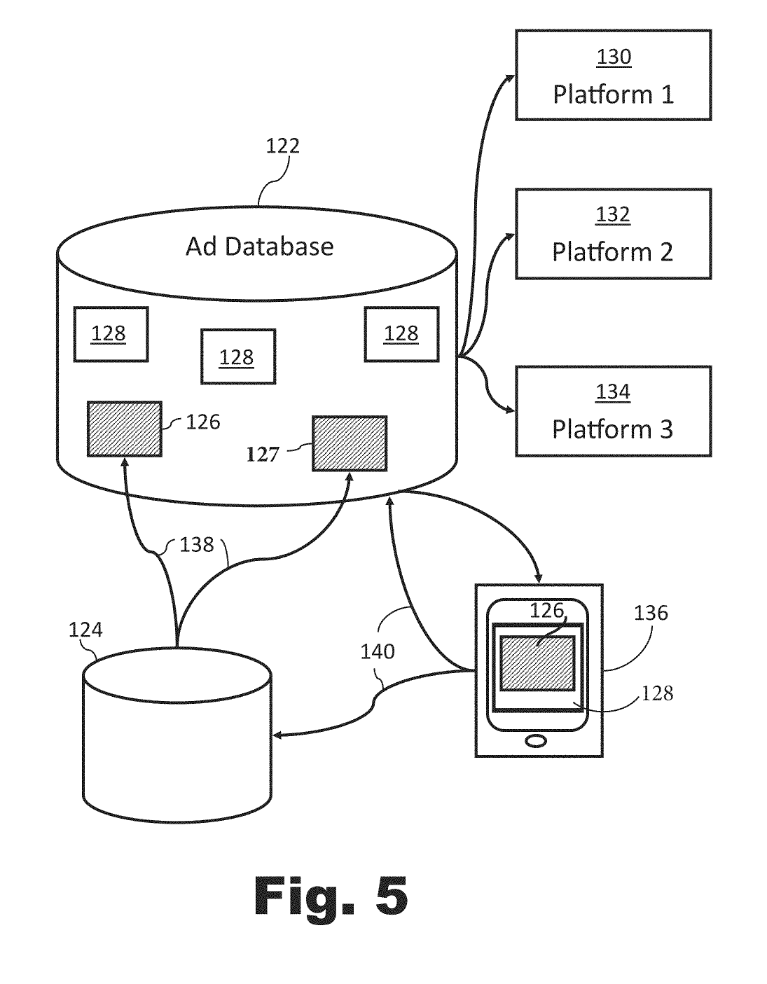

Referring to FIG. 5, an example of an ad database 122 of the system may include a cloud-hosted database indexed by an advertiser. An advertiser's ads 128 and the personal glows 126 of users may be delivered to the ad database when the advertiser completes the glow ad design process and the users complete the personal glow design process. An advertiser's ads may be stored in the ad database and sent to a user when called for delivery. For example an ad and a personal glow 126 may be selected by the glow server 124 to be delivered from the ad database 122 to one of multiple platforms 130, 132, 134, or to a user's mobile device 136. A digital ad 128 is shown in the example on the user's mobile device 136, incorporated with the personal glow 126 in the digital ad 128.

The ad database 122 may store digital ads 128 in non-volatile memory that do not have a glow effect connected to the ad. The digital ads 128 may be received from the glow server 124 or from a different source. The ad database 122 may store personal glows 126 and advertiser glows 127 in non-volatile memory.

The glow server 124 may include an ad packaging and export module which may include a process to attach tags 138 that may enable a glow ad to be exported to an advertiser's or third party's ad database without losing connectivity to the glow server system.

Tags 138 may include a communications tag to enable a glow ad to receive and transmit communications from the glow server system even on a third party's database. Communications tags may include a counting tag to enable counted impressions to be communicated back to the glow server system.

When an ad 128 with a personal glow 126 or an advertiser glow 127 is sent to one of the ad platforms such as the mobile device 136, tags may enable the ad platform to gather user interaction/engagement data 140 and send the user interaction data 140 to the glow server 124 to be stored in non-volatile memory.

Digital ads 128, personal glows 126, and advertiser glows 127 may be delivered to multiple different ad platforms as described in other parts of this document. For example, ad platform one, 130 may be a digital billboard, ad platform two, 132 may be an advertisement in a side bar on a social media site, ad platform three, 134 may be a television in a restaurant that delivers ads, and mobile device 136 may be a cell phone, tablet, wearable device with a display, or other mobile device. Platforms may include projectors that project light onto a product or available item or seat, virtual reality and augmented reality systems, and other platforms.

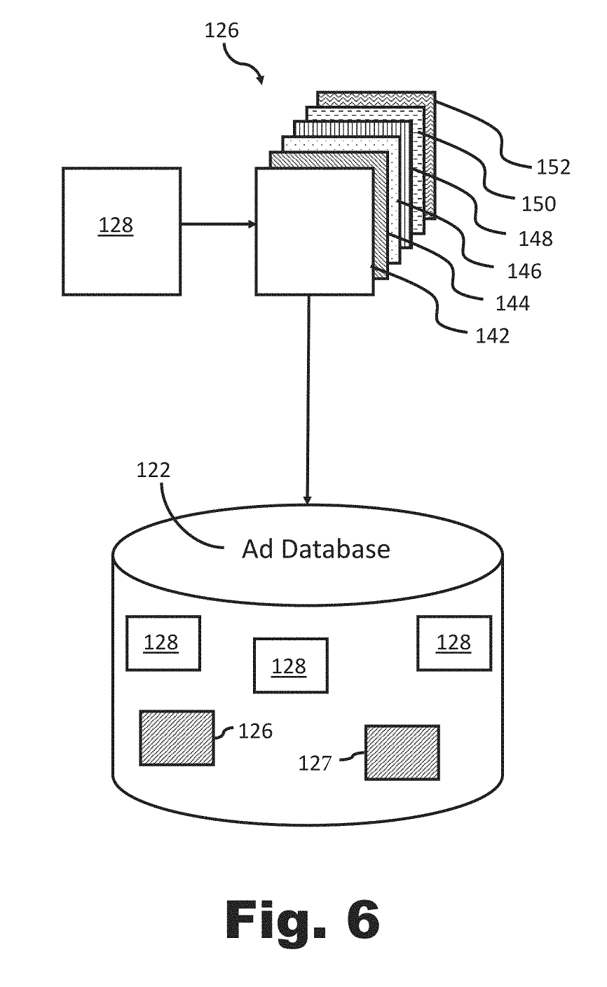

Referring to FIG. 6, in some embodiments a digital ad 128 may be with a personal glow 126 or an advertiser glow 127. In some embodiment a digital ad 128 may include ad content 142 to be displayed (may be multiple layers—i.e. initial, display if clicked, video, offer); and various tags, which may be piggybacked computer code to enable the glow ad functionality. Glow ad tags may include an ad delivery tag 144 with rules for delivery of the ad; a glow insertion tag 146 for the glow (how to insert the glow elements); an interactivity tag 148 (which may include content of the offer and what happens when user clicks in specific locations); an impression counter 150 (to collect impressions, track and store impression data, and communicate impressions data back to glow server system and, which may send data to advertiser for billing and user engagement information); and a communication tag 152 to enable communications to and from the glow server system. In some embodiments a glow ad 126 may have more or less tags than in this example.

In some embodiments personal glows 126 and advertiser glows 127 may be stored on an ad database 122. A personal glow 126 may be delivered as an ad in some situations without additional content or tags. A digital ad 128 may be delivered ad without the glow technology, or it may be delivered with the glow technology.

Because the glow technology may be inserted into the individual ads, it may travel with each ad wherever the ad is delivered. In some embodiments the glow technology may be portable in that it may be used without relying on any special code in a user's device to deliver a glow ad but rather the glow ad may carry with it all the code needed to deliver the glow and other functionality to a wide variety of devices over a wide variety of platforms and communicate with the glow server system as needed.

In embodiments where a digital ad with glow is delivered outside traditional media for targeted digital advertising (traditional digital advertising may include mobile devices, websites, social media), a glow might signal to a user that an engagement opportunity is available should the user be interested. If the user is interested at that time, the user may choose to engage by looking at the user's mobile device to view the glow ad. Or, a user may choose not to engage. A glow may signal a user to interact in other ways that may not require the user to have or use a mobile device, such as purchasing an item that displays the users personal glow, interact with a specific representative at a commercial location, or enter a section or a department of a commercial location.

A glow server system may provide advertisements with a lower annoyance factor: dynamic glow ads may allow the user know an offer or ad or more information is matched to their interests when it contains their own personal glow.

A glow server system may provide content with higher relevance to the user through better targeting: because the user has defined their preferences, the system may target ads using an “opt-in” system rather than an “opt-out” system. A glow server system may provide enhanced accuracy in targeting by capturing a user's biometric information, such a fingerprint, face or other identifying characteristics, and matching it to a user's stored biometric information as verification. In some embodiments a system can identify the user and deliver relevant and personalized advertising based on facial recognition.

A glow server system may provide better engagement by users: because the ads may be better targeted and also dynamic and interactive, the user may be more apt to engage with the ad. Moreover, as noted above, the system provides that an ad may be an offer, and more particularly, a geo-targeted and/or time limited offer. A user is more likely to purchase an offer “on the spot”, i.e. immediately upon seeing the offer, if the offer is geo-targeted or time limited. Because the system may enable not just dynamic but also interactive ads, an ad may be designed as an offer with a point-of-purchase opportunity (such as “click to buy”). A glow server system may provide enhanced security in connection with a point-of-purchase opportunity by capturing a user's biometric information at the point of purchase, such as a fingerprint, and matching it to the user's stored biometric information as verification that the purchaser is indeed a user with authority to draw funds from the payment account. Another type of interactive ad delivered by the system may be a “gamified” ad where the user may play a game or a test of knowledge or skills in order to unlock a prize or offer. Increased meaningful engagement with ads means a much higher chance of converting the user into a sale either at the moment of engagement or soon thereafter.

A glow server system may provide positive brand reaction. Prior systems may create negative brand feelings (annoyance, frustration) when a user is confronted with an ad for a brand's product. Applicant's system, however, may foster positive brand feelings, e.g. brand loyalty, as a user chooses his favorite brands and communicates his interest in receiving offers from them. Users increasingly appreciate having a choice of which ads to see and when to see them. The use of glow technology to communicate the existence of a personalized ad and information about that ad is another way applicant's system allows users to choose whether and when they wish to view certain ads. Because the communication is accomplished by alerting without interruption of the user's activities and without undue distraction, users may find them respectful and helpful rather than frustrating and annoying.

The glow server system may provide brands with more options in designing ads: advertisers may design and build their ad using their choice of tools from a toolbox including a choice of how the “glow” effects are used in the ad and even custom elements.

The glow technology, including the dynamic interactive icons described in applicant's prior patent applications (from which priority is claimed) may be used to deliver dynamic, interactive ads across digital platforms (including social media platforms, browsers and other digital platforms) and even outside the traditional digital platforms. A user may attach her personal glow to an item she encounters in an ad or website to let others in her network know she recommends it. Those in her network, familiar with her personal glow, may see the ad with her personal glow and feel a greater degree of trust in the brand or product because they understand she recommends the item or company.

In some embodiments an ad exchange Demand Side Platform (DSP) model may be used to determine which ads to deliver to a user, and the fee to the advertiser for delivering the ad. In some embodiments a personalized glow element may be part of an ad exchange model, where advertisers bid to deliver personalized glow ads, and the advertiser with the highest bid will have its personalized glow ad be delivered when the offer matches or correlates to the user's profile.

In some embodiments the glow technology may be portable and may travel with the digital ad as it is served to different platforms. More specifically, the tags in the digital ad may piggyback on the traditional code which directs the browser, app or other destination to display the digital ad; and the tags may include a data capture module which includes an impression counter and the code necessary to send the captured data (including number and type of impressions and enhanced engagement data) back to the glow ad server where it is processed (for invoicing the advertiser and delivering orders or purchases from the viewer) and stored for future use (which includes tracking whether user opted out of that brand; how the user interacted with the ad; whether the user purchased; user captured data re location and/or other data desired by the advertiser).

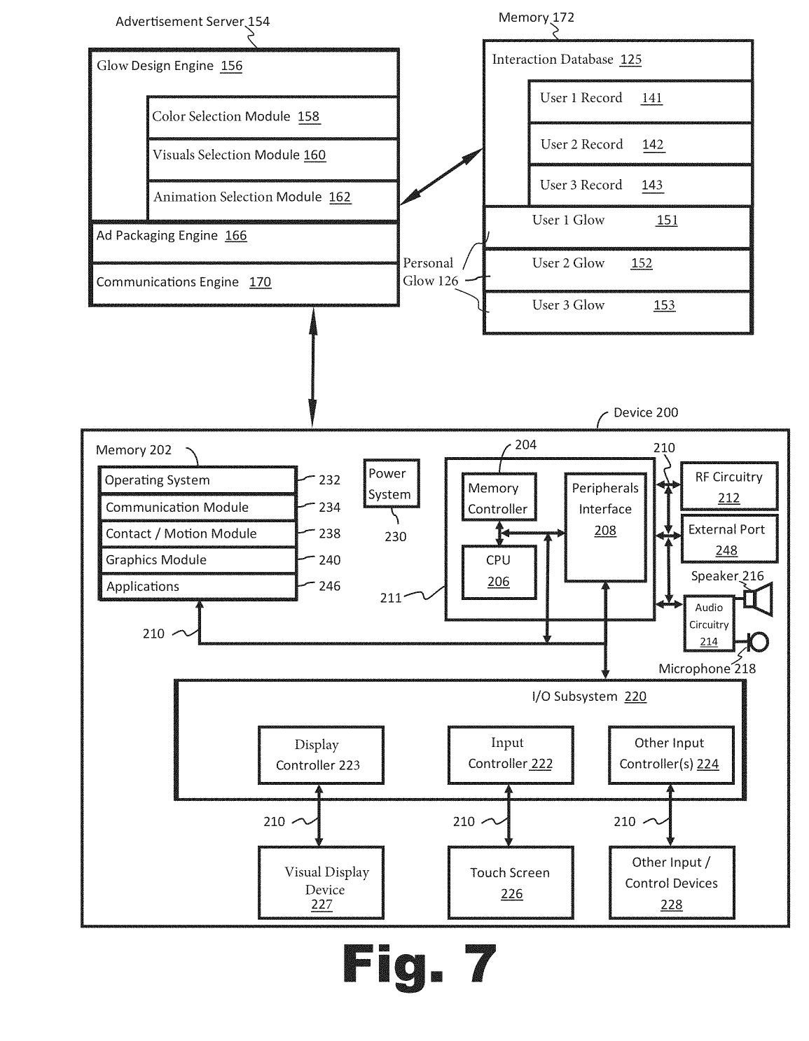

FIG. 7 illustrates an advertisement server 154 connected to memory 172, and which may be communicatively connected to an electronic device 200, according to some embodiments.

In some embodiments the advertisement server 154 may include a glow design engine 156, an ad packaging engine 166, a glow insertion engine 168 and/or a communications engine 170. The glow design engine 156 may include a color selection module 158, a visuals selection module 160 and/or an animation selection module 162. The ad design engine 156 may include a glow design module with a library of glow effects.

The color selection module 158 may include the include a display of a color palette that allows a user to choose one or more colors to be used in the personal glow 126. The color selection module 158 may allow an advertiser to insert colors as borders, backgrounds, patterns or using other visual effects into an ad that can be viewed by users.

The visuals selection module 160 may allow a user to select visuals such as shapes, images, pictures and patterns to be used as part of the personal glow 126.

The animation selection module 162 may allow a user to select animation of the glow, such circles changing from large to small and back to small, or a rotation of the image or part of the image, changing colors.

The advertisement server 154 may match ad attributes as discussed in prior patent applications incorporated herein, and may insert the personal glow into an ad when there the ad attributes are correlated to the preferences and profile of the user.

The ad packaging engine 166 may assemble ad content 142 and prepare the ad to be delivered on various platforms. The ad packaging engine 166 may convert the ad into the proper format for delivery. The ad packaging engine 166 may prepare the personal glow 126 to incorporated into or with an ad and then export the ad to its intended destination, which may include, a glow server, the advertiser's database, an ad exchange, or the targeted user. The ad packaging engine 166 may prepare parts of the glow ad to work together and to work with the glow server.

The communications engine 170 may insert a communications tag 152 into a glow ad 126. The communications engine 170 may receive information related to delivery and interaction with the ad, and enable communication from the memory, and device 200.

The device 200 may include a memory 202, a memory controller 204, one or more processing units (CPU's) 206, a peripherals interface 208, RF circuitry 212, audio circuitry 214, a speaker 216, a microphone 218, an input/output (I/O) subsystem 220, a touch screen 226, visual display device 227, or other input or control devices 228, and one or more cameras 248. These components may communicate over the one or more communication buses or signal lines 210. The device 200 can be any portable electronic device, including but not limited to a handheld computer, a tablet computer, laptop computer, a mobile phone, a digital watch or other “wearables”, a media player, a personal digital assistant (PDA), or the like, including a combination of two or more of these items, and one or more of these items may be a hand-held electronic communication device. It should be appreciated that the device 200 is only one example of a hand held electronic communication device 200, and that the device 200 may have more or fewer components than shown, or a different configuration of components. The various components shown in FIG. 4 may be implemented in hardware, software or a combination of both hardware and software, including one or more signal processing or application specific integrated circuits.

The memory 202 may include high speed random access memory and may also include non-volatile memory, such as one or more magnetic disk storage devices, flash memory devices, or other non-volatile solid state memory devices. In some embodiments, the memory 202 may further include storage remotely located from the one or more processors 206, for instance network attached storage accessed via the RF circuitry 212 and a communications network (not shown) such as the Internet, intranet(s), Local Area Networks (LANs), Wide Local Area Networks (WLANs), Storage Area Networks (SANs) and the like, or any suitable combination thereof. Access to the memory 202 by other components of the device 200, such as the CPU 206 and the peripherals interface 208, may be controlled by the memory controller 204.

The peripherals interface 208 couples the input and output peripherals of the device to the CPU 206 and the memory 202. The one or more processors 206 run various software programs or sets of instructions stored in the memory 202 to perform various functions for the device 200 and to process data.

In some embodiments, the peripherals interface 208, the CPU 206, and the memory controller 204 may be implemented on a single chip, such as a chip 211. In some other embodiments, they may be implemented on separate chips.

The RF (radio frequency) circuitry 212 receives and sends electromagnetic waves. The RF circuitry 212 converts electrical signals to and from electromagnetic waves and communicates with communications networks and other communications devices via the electromagnetic waves. The RF circuitry 212 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 212 may communicate with the networks, such as the Internet, also referred to as the World Wide Web (WWW), an Intranet or a wireless network, such as a cellular telephone network, a wireless local area network (LAN) or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g or IEEE 802.11n, IEEE 802.11ac etc.), voice over Internet Protocol (VoIP), Wi-MAX, a protocol for email, instant messaging, or Short Message Service (SMS)), or any other suitable communication protocol, including communication protocols not yet developed as of the filing date of this document.

The audio circuitry 214, the speaker 216, and the microphone 218 provide an audio interface between a user and the device 200. The audio circuitry 214 receives audio data from the peripherals interface 208, converts the audio data to an electrical signal, and transmits the electrical signal to the speaker 216. The speaker 216 converts the electrical signal to human-audible sound waves. The audio circuitry 214 also receives electrical signals converted by the microphone 218 from sound waves.

The I/O subsystem 220 provides the interface between input/output peripherals on the device 200, such as the touch screen 226, visual display device 227, and other input/control devices 228, and the peripherals interface 208. The I/O subsystem 220 includes a touch-screen controller 222 and one or more input controllers 224 for other input or control devices. The one or more input controllers 224 receive/send electrical signals from/to other input or control devices 228. The other input/control devices 228 may include physical buttons (e.g., push buttons, rocker buttons, etc.), dials, slider switches, sticks, and so forth.

In some embodiments the touch screen 226 provides both an output interface and an input interface between the device and a user. The input controller 222 receives/sends electrical signals from/to the touch screen 226. The touch screen 226 displays visual output to the user. The visual output may include text, graphics, video, and any combination thereof. Some or all of the visual output may correspond to user-interface objects, for example soft keys or soft buttons for user input.

In some embodiments the touch screen 226 also accepts input from the user based on haptic or tactile contact. The touch screen 226 forms a touch-sensitive surface that accepts user input. The touch screen 226 and the input controller 222 (along with any associated modules or sets of instructions in the memory 202) detects contact (and any movement or break of the contact) on the touch screen 226 and converts the detected contact into interaction with user-interface objects. The touch screen 226 may use LCD (liquid crystal display) technology, or LPD (light emitting polymer display) technology, although other display technologies may be used in other embodiments.

In some embodiments, in addition to the touch screen 226, the device 200 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 226 or an extension of the touch-sensitive surface formed by the touch screen 226. The touchpad may allow for fingerprint scanning or other biometric input.

The device 200 also includes a power system 230 for powering the various components. The power system 230 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

In some embodiments, the software components include an operating system 232, a communication module (or set of instructions) 234, a contact/motion module (or set of instructions) 238, a graphics module (or set of instructions) 240, and one or more applications 246 (or set of instructions).

The operating system 232 (e.g., Darwin, RTXC, LINUX, UNIX, OS X, WINDOWS, or an embedded operating system such as VxWorks) includes various software components or drivers for controlling and managing general system tasks (e.g., memory management, storage device control, power management, etc.) and facilitates communication between various hardware and software components.

The communication module 234 facilitates communication with other devices and includes various software components for handling data received by the RF circuitry 212.

One or more cameras 248 may be used to capture images, video that can be transmitted through the communication module 234 and the RF circuitry 212. In some embodiments a device 200 may include a first camera the back side of the device 200, and a second camera 248 on the front side, which is opposite the back side, and which may be the same side as a visual display device. In an embodiment with a front side and a back side camera 248, the device 200 may capture images from the back side of the camera, and then enhance the video with graphics and display the enhanced video on the visual display device 200. In some embodiments images or video are transmitted to a server where they are enhanced and then transmitted back to the device for display on the visual display device 227. Enhanced images or video may allow for augmented reality, and may be used with a user's personal glow as shown in FIGS. 8 through 18.

The contact/motion module 238 detects contact with the touch screen 226, in conjunction with the input controller 222. The contact/motion module 238 includes various software components for performing various operations related to detection of contact with the touch screen 226, such as determining if contact has occurred, determining if there is movement of the contact and tracking the movement across the touch screen, and determining if the contact has been broken. In some embodiments, the contact/motion module 138 and the touch-screen controller 122 also detect contact on the touchpad.

The graphics module 240 includes software components for rendering and displaying graphics on a visual display device 227. Graphics module 240 may communicate with display controller 223. In some embodiments a device may be used as both an input device and a display device, such as a touch screen 226. Note that the term “graphics” includes any object, image, or color that can be displayed to a user, including without limitation text, web pages, icons (such as user-interface objects including soft keys), digital images, videos, animations and the like.

The one or more applications 246 can include any applications installed on the device 200, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player (which plays back recorded music stored in one or more files, such as MP3 or AAC files), etc.

The advertisement server 154 may deliver ads to other devices which are not mobile device, and which may have more or less modules, systems, and functions than device 200. For example, the advertisement server may deliver advertisements to fixed monitor, which may be a representative monitor that is associated with a representative in a commercial space, or a projector or digital billboard that may project or show an image in a commercial space as shown in FIG. 14.

Tracking tags may be digital tags corresponding to a user's face, body, physical or digital characteristics. Tracking tags may originate from the user's person, wearables or other devices carried or worn by the user (active identification). Alternatively, tracking tags may originate from a passive identification device at a location, such as a camera or a biometric sensor or capture device, such as a voice analyzer, face scanner, fingerprint reader or biometric scanner.

A user may use her glow to communicate to others (both in her network and outside her network) that she has a connection to something. For example, a user may come across a product or service or offer she likes or wishes to save for later, she may attach her personal glow to a frame around the image, or associated with the image, or the image may otherwise display her glow by virtue of her attaching her personal glow to the image.

A brand or commercial location may use a user's personal glow to indicate to the user that an offer or product or service is recommended or designated or meant specifically for that user based on the user's preferences and behavior. A brand's use of users' personal glows enables the brand both to gain the user's attention and also to indicate that the item or moment is directed uniquely to that user. Alternatively, a specific, signature glow may be shared by a particular group, such as fans of a particular sports team or members of a traveling tour group, indicating that a particular offer, product, service or moment is designated for members of that group uniquely.

One's personal glow is associated with their favorites, their preferences, their interests, purchase history, etc. In this sense one's personal glow may be very roughly analogous to a tracking “cookie,” as known in the art, but with these important differences:

Unlike tracking pixels and cookies, users are likely to be aware of their personal glow and engage with it intentionally, whereas tracking cookies are covert and outside the users' control unless a savvy user opts out by using a private browsing session. Because a user's glow represents and reflects his interests, preferences and express choices about how he wishes to engage with brands and others, users embrace their glows. Users are likely to customize their glow, take ownership of their glow, personalize it and control it. They are invested in their personal glow, it is not something secretly forced upon them by their browsers and the webpages and digital offers they peruse.

Unlike tracking pixels and cookies (which require users to opt out), users opt in to the use of glow by attaching the glow to their profile, or by creating their own glow. Users may choose how they wish to interact with offers and brands through the profile. Because they opt in, they may have a more positive feeling about glow offers sent to them.

Unlike digital offers delivered by tracking pixels and cookies, offers and information delivered by glow are not obtrusive—they do not interrupt a user's experience on a screen or in a place, they merely communicate that an offer of a particular kind is available should the user choose to engage and learn more. This is an increasingly significant difference as consumers become increasingly hostile toward obtrusive digital ads and offers.

In some embodiments advertising may include delivery only of a personal glow to a display device. An example system may be used in a commercial location. By way of example a shoe store may use disclosed embodiments when a user is using augmented reality. The user may enter the shoe store and have the personal glow enabled using augmented reality through a headset or a mobile device with a camera and a display, the items in the shoe store that are preferred can have a personal glow visual indicator. For example, if a user wears a size 10 shoe, then the system can display a glow around shelves or individual items that are size 10 shoes. If the individual has indicated a preference of certain a brand, the locations where that brand are located and offered can have a personal glow visual indicator overlayed over the image of the inside of the store using the augmented reality display.

The user can also indicate the style of shoe that they prefer and the system can highlight displays or locations of merchandise that match the style of shoe.

A user may indicate a size, brand, style, type, color, material, location or other preference by completing a questionnaire or by allowing past purchases or browsing data to be used as an indicator.

In some embodiments a store may have multiple digital displays or may have a digital display that responds to a user's preferences. The display could include a map of the store, and sections of the map may include the personal glow visual indicator based on a user's indicated preferences. In some embodiments a store may have a display associated with a section of the store and the display may include a user's personal glow visual indicator when there are one or more items in the sections of the store that are correlated to one or more user preferences. A digital display in a store may include more than one person's personal glow at the same time. In some embodiments a mobile device associated with a user communicates to a server with location information. The location information may be used to send the personal glow to one or more displays that are in the proximity of the user. In other embodiments cameras, such as security cameras, may capture images of faces and facial recognition may be used to identify the location and user profile of a user, and then to deliver personal glow with advertisements or as advertisements.

In some embodiments a product may incorporate a display such as a flexible display for clothing, or a mobile electronic device that is on display for sale. The product's display may show the personal glow of a user as an advertisement.

In some embodiments a user may purchase an item before arriving at a store or pickup location and the users personal glow may be displayed on the item. Personal glow may be displayed on a locker or storage container that contains items or merchandise that has been purchased by the user and is ready for pick up.

A digital display maybe a personal digital display of the user or a public digital display. For example, a digital display in a store that multiple users can see at the same time. Personal glows may be displayed at the same time, or rotate position.

A user can attach his personal glow to a product he sees in an ad to indicate he wishes to see it in person. When he passes within a designated distance of the product, whether it is in a store he is approaching on the street or in a mall, or whether it is on a person nearby, or whether it is in a store he is driving toward, etc., he may receive a notification (on his mobile device or integrated car computer display or GPS, for example) that the item he wanted to see is near and directing him toward it. The notification may also use a particular commercial glow attributed to parameters of a special offer or the distance to be traveled, as previously disclosed in priority documents.

In some embodiments the notification that an item is nearby may include a deal, a reward or a “one-click-purchase” opportunity where a person can purchase the item on their mobile device and pick it up in the store they are near. The purchase record captured by the system and devices at each end of the transaction may include the buyer's personal glow, which then would make it easy for the store to identify the precise item purchased by the person—the glows may match or recognize one another, indicating that the item has been purchased by the user with the matching glow who will be retrieving it from the store.

In some embodiments the user's personal glow may indicate the user wishes to see the product in person and is on her way to the store to do so. The system may transmit information to the seller indicating approximately when the user will be arriving at the store so that the seller may have a demonstration or dressing room already ready for the user when she arrives. In these ways and others, use of personal glow facilitates the purchase and sale of merchandise in which a particular user has expressed interest, making it more convenient and efficient for both buyer and seller. In some embodiments, a representative of the business may have a wearable device, such as a vest with one or more displays, and the user's glow may be shown on the representative's wearable display to let the user know that this representative is in charge of the user's transaction. This system may allow a representative to complete the transaction by verifying the user's personal glow without the need for the representative to be waiting at a check out, thereby creating greater efficiency for the business and for the user.

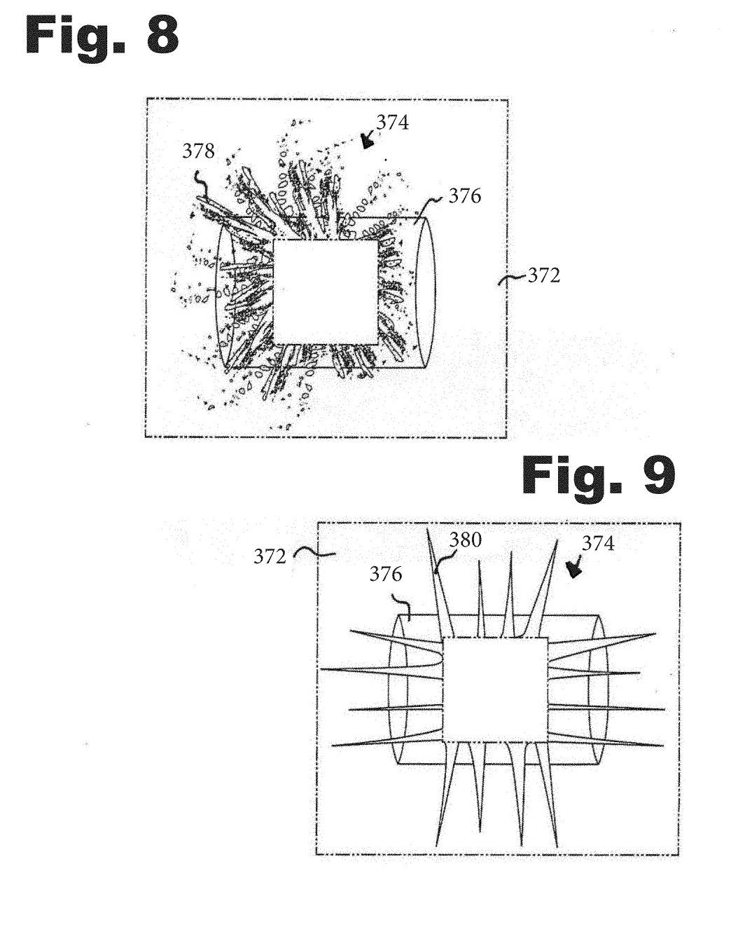

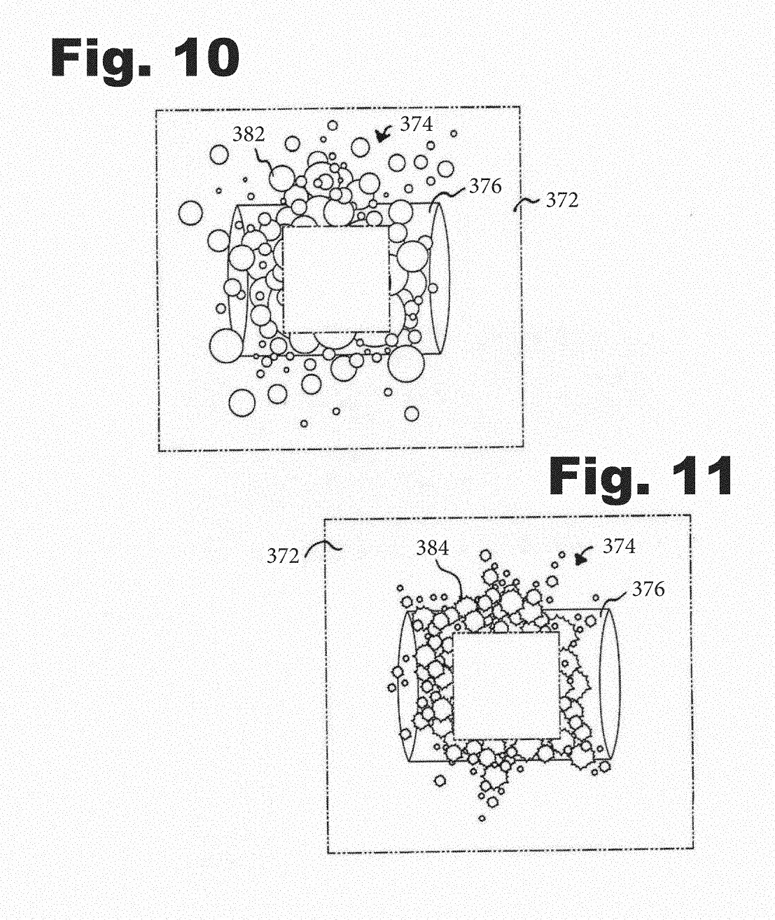

In some embodiments an icon 376 can be used to communicate information to the observer or user by displaying information in a manner disclosed herein. In some embodiments, information is displayed or expressed by the icon 376 “glowing” in order to indicate that certain information is intended to be communicated. As used herein, the term “glow” 374 refers to giving off of light or radiance that emanates from the icon 376 and is visually ascertainable and distinguishable on the display screen 372 of the device 100. In addition, the “glow” 374 as used herein, may refer to various illustrative effects that emanate from the icon, such as those illustrated in FIGS. 8 through 12 and FIGS. 14 through 20. In further embodiments, the glow may be configured to various shapes, such as, but not limited to a splash 378, illustrated in FIG. 8, a star 380, illustrated in FIG. 9; bubbles 382, illustrated in FIG. 10, and a sun 384, illustrated in FIG. 11. The term “glow” 374 as used herein, may also incorporate pop-out design 170. The invention is not limited to the shapes or pictorial effects illustrated by the drawings, and may include any other shapes or pictorial effects that may be pleasing to users or icon owners. Variation in different glow 374 types may allow different icon owners, merchants, for example, to distinguish their brands and the “look and feel” of their icons.

In some embodiments a brand owner may customize the glow for offers related to their brand. A advertiser or user may upload or associate an image file that may be used as part of the glow. For example the bubbles 382 in FIG. 10 may be replaced by an image of a brand logo or other branding item. In some embodiments a brand owner, advertiser, or user may upload a small image file, including a favicon file, to be used as a moving image or glow. In some embodiments a brand owner may upload an image file that has colors, patterns or shapes that the brand owner desires to be associated with their brand, to be used as moving images for at least part of the glow.

In some embodiments either the entire icon 376 may glow 374 or only segments or portions of the icon 376 may glow 374 according to various embodiments.

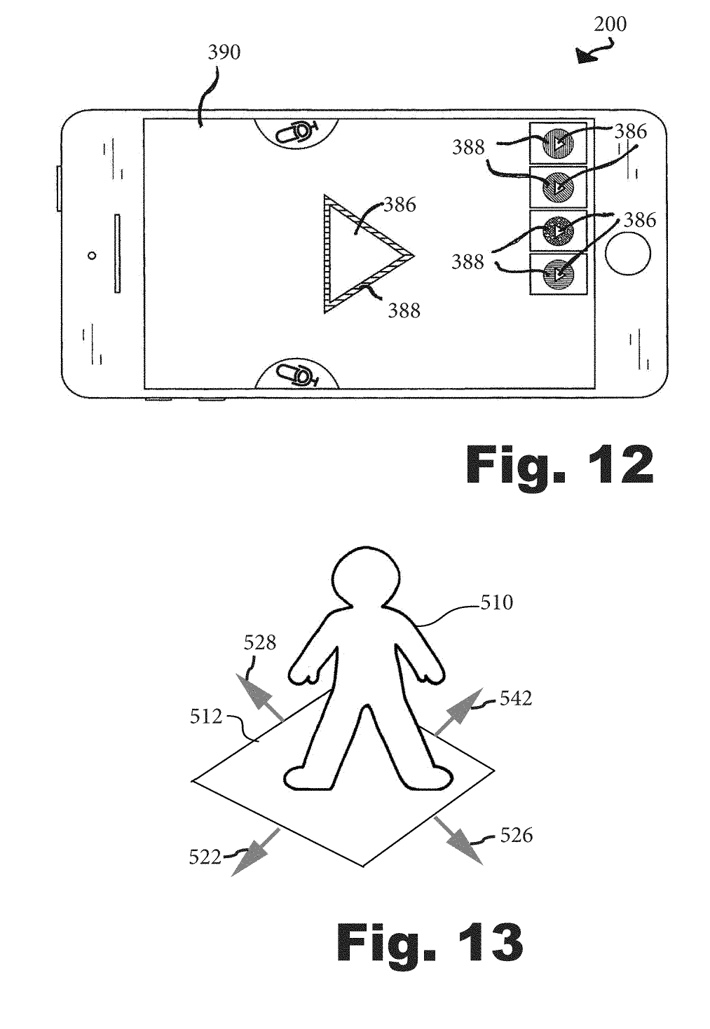

FIG. 12 may represent a video screen 15 The video screen 15 may be a full screen video player 390 with a play button 386 for one or more videos, and an outline color glow 388 that is based on preferences of the user and may be a color that represents the personal glow of the user. The system represented in FIG. 12 may enable the user to make selections by presenting the user's glow and preferences with commercial video options. For example, picking among one or many hotels in a city, the user can see if a particular selection is rated high by using a certain criteria. In one embodiment, this can be accomplished by the system or previous user selections or by communicating with other default or user selected sites such as Tripadvisor®.

FIG. 14 shows an example use of digital displays by service representatives, for example in a bank. A commercial location may have multiple, representative available, such as a first representative 410, a second representative 412, and a third representative 414. In the example shown in FIG. 14, each representative may have display, including a first representative display 416, a second representative display 418, and a third representative display 420. In the example embodiment of FIG. 14, users may be waiting in line and some of the users may have a personal glow that they have shared with the commercial location, such as a bank. When the user enters the bank the system may automatically identify the users that have opted in using communication with the user's mobile device, or using facial recognition, or another manner of identifying the specific user. The system may then set up a queue, and may include users who do not have an opt in by automatically recognizing their presence, even without linking them to a specific user profile or identification.

In the example embodiment the system may automatically assign a user to a representative when the user is next in the queue, and if the user has a personal glow, the personal glow is shown in the representative display for the representative that is assigned to assist the user by the automatic queue. For example, a first user may have a first personal glow 422, which may be shown on the first representative display 416 when the first representative is available. The first representative 410 may also be sent the information for the first user so that the first representative 410 can provide faster and more personalized service.

In some embodiments, a user may have a mobile device, that communicates with the system in the commercial location. When the user enters the commercial location, or comes within a quantum advertising zone, the system may communicate with the user's mobile device and confirm whether the user desires service from the commercial location. If the user responds that they would like service, the system can confirm the type of product or service, or any orders that the user wishes to place. When a representative is ready to serve the user, the mobile device may display the user's personal glow, to let the user know that the representative is ready to receive them. The representative may have a representative display and the user may match their personal glow to the representative's display. This may allow a commercial location to invite users into their location that are nearby with an offer to serve them, and allow them to be placed in the queue automatically in a personalized way without the need for an employee to enter them in the queue. The user may also wait in a comfortable area knowing that they are in the queue. In some embodiments the system may provide the user personalized offers or information while they are waiting in order to increase business opportunities, and to reduce the amount of work that a representative will need to do when they interact with the user.

The system may be able to serve customers who have not opted in by including them in the queue. For example, in the example embodiment discussed with FIG. 4, a second user without a user profile may be directed to the second representative 412. The second representative display 418 may display a message, or not display anything, and the second representative may assist the customer through traditional methods.

In some embodiments the selection of a representative may be based at least in part on the user's profile. As an example, if a third user prefers to speak Spanish, and has an opt in profile that indicates Spanish as a preferred language, then the system may automatically send the third user to a representative that speaks Spanish. In the example discussed, the third user has a user profile with a third personal glow 424, and the third representative 414 speaks Spanish, so the system automatically directs the third user to the third representative 414 by displaying the third personal glow on the third representative display 420.

The system may route users to representatives base on preferences marked entered by a user, or preferences entered by a representative, or by preferences based on user actions. In an example embodiment a first camera 426 may monitor a user that interacts with the first representative 410, and a second camera 428 may monitor interactions with the second representative 412, and a third camera 430 may monitor interactions with the third representative 414. When a user interacts with a representative, the camera may capture images and determine whether a person is smiling, or record other indications of satisfaction or dissatisfaction. In some embodiments the system may increase the chances that they will route a user to a specific representative if the user has expressed satisfaction in past interactions with the specific representative, for example by smiling. In some embodiments a user may express satisfaction through a survey offered to the user after their interaction.

When a User enters a physical space, such as a store, sensors on or in her wearables, accessories and/or devices send a signal or receive a signal or both. “Sensors” as used herein means devices or components capable of receiving and sending, or either. Sending and receiving are enabled using communication technology known in the art—currently Bluetooth®, WiFi, NFC, RFID, but which communication technology may be any wireless communication technology now known or hereinafter invented.

As the User moves through the space and interacts (or chooses not to interact) with interaction opportunities in the space, a unique algorithm of identification is created.

An algorithm assigns alphanumeric identifiers to each User in each Space depending on various parameters and user interactions (or user non-interactions, i.e. choosing not to interact) within the space. Alphanumeric identifiers herein are called “numbers” but should be understood to include any combination of numbers or letters.

For example, User A is assigned a number. When User A walks into Restaurant R, a system algorithm senses User A in Restaurant R and creates a Quantum Number consisting of User A's unique number followed by Restaurant R's unique number, followed by a time code, indicating that right at that moment in time, User A was located in Restaurant R. The number string is called a “Quantum Number” because it is ever changing as User A moves around and interacts (or chooses not to interact) in the digital and physical space. Additional parameters may be assigned numbers, collected and transmitted via sensors to the system server(s), including but not limited to digital characteristics (such as virtual reality enabled, augmented reality enabled, mobile device enabled, opt-in mobile app enabled, personal identifier enabled) and/or physical characteristics (such as facial recognition, object proximity and/or interaction, precise location inside/outside). VR-enabled, for example, means for that user, VR technology is present and ready to receive VR information; AR-enabled means for that user, AR technology is present and ready to receive AR information; mobile device-enabled means for that user, a mobile device of a is present and ready to receive information; Visual Voice™ enabled means that for that user, a device equipped with an opt-in mobile app (such as described and illustrated in applicant's prior application incorporated by reference) is present and ready to receive and transmit information; Personal Identifier enabled means that user has designed or chosen their own Personal Glow.

If user A is Active, meaning he has opted in to use the system, either by signing up at an earlier time (perhaps by accepting an offer through the system) or walking into a space without choosing “passive mode”, then his active status is sensed and captured via assigning a value to be added to that user's quantum number in the active/passive place, for example a value of 1 or X.

If User A is passive, meaning he has not opted in to use the system (or has opted out), then his passive status is sensed and captured via assigning a zero value to be added to that user's quantum number in the active/passive place, for example a value of 0.

As User A moves through the space, interacting or choosing not to interact with opportunities, parameters may be added to her quantum number and timestamped. Interacting can include looking at an item for at least a threshold period of time, smiling, frowning, touching an item, interacting with a display, picking up a sample, picking up a product, querying the name or type of a product with a voice command query or text query, as well as other interactions.

Quantum numbers for each user may be collected and timestamped at each parameter place so they may be analyzed and graphed against time, as one axis, and space or engagement and/or other data points desired so as to view the user's activities over time.

A portion of the quantum number may contain a header that identifies the data structure of that portion of the quantum number. For example if the user is entering a store through a specific entrance at a specific time, the header may include the information that the portion contains date, time and location, and may include other information. In the next portion of the quantum number the user picks up merchandise on display and examines it, the header location and time may contain the display location, indicating that the display is the interaction. In some embodiments the location and time is tracked and stored in the quantum number, and the location is correlated to known locations in the commercial location. In some embodiments the system captures information through a user's mobile device such as a camera on a VR headset. The quantum number may include what product the user handles. In some embodiments the merchandise may have tags or emitters that may recognized by a mobile device or by sensors in the commercial establishment. Then if a user walks past another display and does not interact with it this may be recorded as another interaction.

Alternatively or in conjunction with any of the above uses, the system may be used to relay information, such as to help a User recognize objects in the physical space that have significance for that User, such as an available chair, a pair of shoes a User had been investigating online in the User's size, a restaurant in view that is top-rated for dishes the User frequently eats, selections in a restaurant menu or at a cafeteria that are approved for a User's dietary needs or goals. For example, if a User walks into a physical space with AR (Augmented Reality) technology, such as AR glasses, the system is triggered, reads (senses) the User, recognizes that the User is AR-enabled, checks whether the User is Active or Passive, if Active obtains the User's digital profile and preferences, runs through applicable filters and delivers to the User's AR technology a digital overlay with glow providing User-specific, relevant information about various objects in the field of view. In other words, the system is useful for both commercial, non-commercial and mixed commercial/noncommercial communication to a User and for collecting passive data from Users (by capturing via Quantum Numbers their movements and interactions in the space) as well as collecting active data from Users (by providing opportunities for them to engage with information and offers through the system, such as by clicking “learn more” or using a gesture on a screen or a vocal command to instruct the system to further explore the opportunity, send a message, purchase, request a discount, decline an offer, decline all offers, switch to passive, call a hostess, return an item, or whatever interaction opportunities the brand or business choose to offer.)

Significant advantages of the system are: it captures information about the user's preferences, buying habits and engagement that goes well beyond a user's stated preferences; it captures such information as a user interacts and moves through a space in a method that may be collected, stored, analyzed, graphed and used; it provides a mechanism to deliver hyper-targeted, refined engagement opportunities as a user is still engaging with the brand; it allows a user to opt in or opt out on two levels (one level being anonymity and another level being “glow” or “no glow”) while still collecting data even on anonymous users (for aggregating and studying); for fully opted in users it provides a fun, non-obtrusive way to engage with brands and businesses that celebrates their individuality, feels personalized and gives the user control, thus increasing the likelihood of a user purchasing from the brand or business.

In some embodiments a storefront may be used for advertisement. FIG. 15 shows one embodiment where a first personal glow 422 is displayed on a digital billboard 432 to communicate to the first user who is associated with the first personal glow 422 that there is a special offer for that user in the store. A projector 436 may project a digital advertisement with a fourth personal glow 438 onto a wall 434 to communicate to a fourth user that there is a special deal associated with the specific brand in the advertisement.

In some embodiments glows of various colors may be used to indicate through augmented reality, or in other ways such as with a digital menu, which menu items are best fits for a user's dietary needs (gluten free, low-sodium, exceptionally nutritious) and which menu items are worst fits for that User's dietary needs.

Those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention. These and other constructions will become obvious to those skilled in the art from the above drawings and detailed description of the preferred embodiments in combination with the claims.

What is claimed is:

1. A computer implemented method of delivering advertising through a digital display device within a defined commercial location, said digital display device being communicatively connected to a server, the computer implemented method comprising:
receiving, by the server, a user identifier of a user that is within the defined commercial location,
receiving, by the server, a first interaction indication including:
a first location indication to correlate a first location of the user within the defined commercial location; and
a first time indication to correlate the first location indication to a first date and time;
storing in a memory by the server, a database record including:
the user identifier;
the first interaction indication; and
additional interaction indications wherein the additional interaction indications include:
an additional location indication to correlate an additional location of the user within the defined commercial location; and
an additional time indication to correlate the additional location indication to an additional date and time;
delivering a visual digital advertisement, by the server, to the digital display device within the defined commercial location based on the database record.

2. The computer implemented method of claim 1, further comprising:
correlating the user identifier to a user profile including user preferences by the server;
and wherein the delivering the visual digital advertisement is further based on the user preferences.

3. The computer implemented method of claim 2, wherein the delivering the visual digital advertisement further includes delivering the visual digital advertisement with a user specific visual enhancement including a user color that is included in the visual digital advertisement.

4. The computer implemented method of claim 3 wherein the user specific visual enhancement further includes a repeating visual variation of the user specific visual enhancement.

5. The computer implemented method of claim 4, wherein the repeating visual variation includes a cycle time of the repeating visual variation.

6. The computer implemented method of claim 1 wherein the first interaction indication further includes a first direction of travel indication that indicates a direction of travel of the user.

7. The computer implemented method of claim 1 wherein the first interaction indication further includes a first emotional response indication to indicate an emotional response of the user.

8. A computer implemented method of delivering advertising through a digital display device within a defined commercial location, said digital display device being communicatively connected to a server, the method comprising:
receiving, by the server, a user identifier of a user that is within the defined commercial location,
correlating the user identifier to a user profile including user preferences and a user specific visual enhancement;
receiving, by the server, a first interaction indication including:
a first location indication to correlate a first location of the user within the defined commercial location; and
a first time indication to correlate the first location indication to a first date and time;
storing in a memory by the server, a database record including:
the user identifier;
the first interaction indication;
delivering a visual digital advertisement, by the server, to the digital display device within the defined commercial location based on the database record, the user preferences and the user specific visual enhancement.

9. The computer implemented method of claim 8 further comprising:
receiving, by the server, a second interaction indication including:
a second location indication to correlate a second location of the user within the defined commercial location; and
a second time indication to correlate the second location indication to a second date and time;
wherein the database record includes the second interaction indication.

10. The computer implemented method of claim 8 wherein the first interaction indication further includes a first direction of travel indication that indicates a direction of travel of the user.

11. The computer implemented method of claim 8 wherein the first interaction indication further includes a first emotional response indication to indicate an emotional response of the user.

12. The computer implemented method of claim 11 wherein the first emotional response indication includes a facial recognition input from a digital camera, the computer implemented method further comprising:
determining whether the user is smiling based on the facial recognition input.

13. The computer implemented method of claim 11, further comprising:
correlating the delivering the visual digital advertisement with the first emotional response indication to determine if the user smiled in response to the delivering the visual digital advertisement.

14. The computer implemented method of claim 8, wherein the digital display device includes a representative display associated with a specific representative of the defined commercial location, wherein the delivering the visual digital advertisement includes delivering the user specific visual enhancement to the representative display to indicate to the user that the specific representative is prepared to serve the user.

15. The computer implemented method of claim 14, further comprising:
correlating the specific representative with the user based on the user profile, wherein the correlating the specific representative with the user is performed prior to the delivering the user specific visual enhancement to the representative display.

16. The computer implemented method of claim 8 where the digital display device includes an augmented reality display, and where the delivering the visual digital advertisement includes highlighting a portion of the augmented reality display.

17. The computer implemented method of claim 8 wherein the digital display device includes a merchandise display that is associated with an item of merchandise, where the delivering the visual digital advertisement includes displaying the user specific visual enhancement on the merchandise display.
